(19) United States
(12) Patent Application Publication
(10) Pub. No.: US 2020/0293496 A1
(43) Pub. Date: Sep. 17, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Takamasa ARAKAWA, Kanagawa (JP)

(73) Assignee: FUJI XEROX CO., LTD., Tokyo (JP)

(21) Appl. No.: 16/518,050

(22) Filed: Jul. 22, 2019

(30) Foreign Application Priority Data
Mar. 13, 2019 (JP) 2019-046045

(51) Int. Cl. G06F 16/17; G06F 16/176

(52) U.S. Cl. CPC G06F 16/1734; G06F 16/176

(57) ABSTRACT

An information processing apparatus includes a recording unit, setting unit, and display controller. The recording unit records user operation information including an execution date and time of an operation performed by user on a file and identification information of user who performed the operation. The setting unit sets a degree of association to increase in a case where two pieces of user operation information are recorded in the memory in response to operations performed by identical user on two different files within a certain period of time, the degree of association being set in degree-of-association information generated in association with a combination of types of operations performed on the two files, the degree of association indicating degree of association between the two files. The display controller performs, in a case where a user selects a file as a target of operation, control to display degree-of-association information corresponding to the file.

### CROSS-REFERENCE TO RELATED APPLICATIONS

This application is based on and claims priority under 35 USC 119 from Japanese Patent Application No. 2019-046045 filed Mar. 13, 2019.

### BACKGROUND

### (i) Technical Field

The present disclosure relates to an information processing apparatus and a non-transitory computer readable medium.

### (ii) Related Art

To manage files associatively, various techniques have been proposed for automatically associating files by referring to operation logs or the like of the files. For example, in Japanese Unexamined Patent Application Publication No. 8-161347, a file name to which reference is made while editing a file and the time are recorded, and, after the editing is completed, the file name and the time are presented to the user to allow the user to select a file to associate.

In addition, techniques have been proposed to associate a document being viewed or edited with another document viewed or edited during that task (for example, Japanese Unexamined Patent Application Publication Nos. 2010-170438 and 2014-021508).

In the related art, two files are associated with each other depending on whether or not there is an operation on a second file during an operation on a first file, and information regarding the associated files is presented to the user.

### SUMMARY

Aspects of non-limiting embodiments of the present disclosure relate to presenting information regarding a related file to a user by referring to the frequency and type of user operation on each file.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a recording unit, a setting unit, and a display controller. The recording unit records, in memory, user operation information including an execution date and time of an operation performed by a user on a file, a type of the operation, and identification information of the user who performed the operation. The setting unit sets a degree of association to increase in a case where two pieces of user operation information are recorded in the memory in response to operations performed by an identical user on two different files within a certain period of time, the degree of association being set in degree-of-association information generated in association with a combination of types of operations performed on the two files, the degree of association indicating the degree of association between the two files. The display controller performs, in a case where a user selects a file as a target of operation, control to display degree-of-association information corresponding to the file.

### BRIEF DESCRIPTION OF THE DRAWINGS

An exemplary embodiment of the present disclosure will be described in detail based on the following figures, wherein:

FIG. 1 is a block diagram of a document management apparatus in an exemplary embodiment;

FIG. 2 is a diagram illustrating an exemplary data configuration of user operation information stored in a user operation information database in the present exemplary embodiment;

FIG. 3 is a flowchart illustrating a degree-of-association information setting process in the present exemplary embodiment;

FIG. 4 is a diagram illustrating an exemplary data configuration of degree-of-association information stored in a degree-of-association information database in the present exemplary embodiment;

FIG. 5 is a diagram illustrating another setting example of the user operation information stored in the user operation information database in the present exemplary embodiment;

FIG. 6 is a diagram illustrating the case in which the degree of association in the degree-of-association information stored in the degree-of-association database is updated in the present exemplary embodiment;

FIG. 7 is a diagram illustrating a screen display example of information regarding the degree of association in the present exemplary embodiment;

FIG. 8 is a diagram illustrating a screen display example of a message regarding an operation on a document in the present exemplary embodiment; and

FIG. 9 is a diagram illustrating a screen display example of another message regarding an operation on a document in the present exemplary embodiment.

### DETAILED DESCRIPTION

Hereinafter, an exemplary embodiment of the present disclosure will be described on the basis of the drawings. In the present exemplary embodiment, the case in which digital document data (hereinafter simply referred to as a “document”) which is one form of a file is handled will be described by way of example.

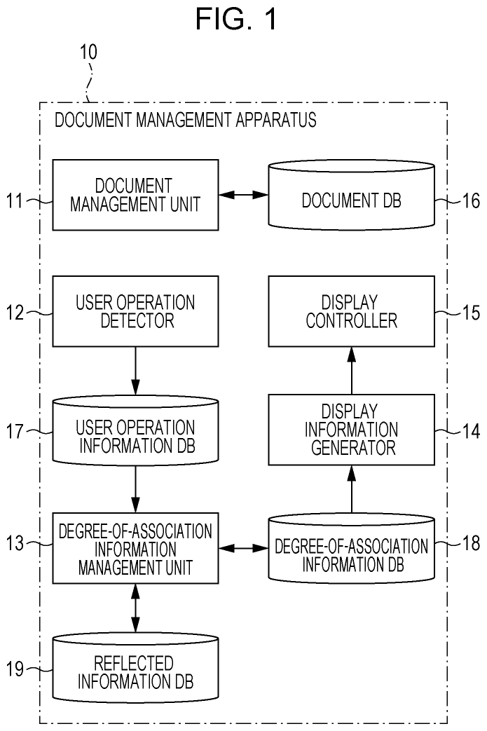

FIG. 1 is a block diagram of a document management apparatus 10 in the present exemplary embodiment. The document management apparatus 10 in the present exemplary embodiment is realized by a computer such as a general server computer. In short, the document management apparatus 10 includes a central processing unit (CPU), memory such as read-only memory (ROM), random-access memory (RAM), and a hard disk drive (HDD), and, in the case of exchanging information with an external system, a network interface. To provide information to the user, the document management apparatus 10 includes a user interface for that purpose, such as a mouse, a keyboard, or a display. Alternatively, the document management apparatus 10 may include a network interface in the case of providing information to the user via a network.

The document management apparatus 10 in the present exemplary embodiment includes a document management unit 11, a user operation detector 12, a degree-of-association information management unit 13, a display information generator 14, a display controller 15, a document database (DB) 16, a user operation information database (DB) 17, a degree-of-association information database (DB) 18, and a reflected information database (DB) 19. Note that elements that are not used in the description of the present exemplary embodiment are omitted from FIG. 1.

Documents that serve as targets managed by the document management apparatus 10 are stored in the document database 16. In response to a request from the user, the document management unit 11 manages a document, such as registering, updating, or deleting of the document. In response to a request from the user, the document management unit 11 provides a document to the user. The user operation detector 12 detects a user operation on a document stored in the document database 16, such as viewing or editing of the document, and registers information regarding the detected user operation as user operation information in the user operation information database 17.

The degree-of-association information management unit 13 manages degree-of-association information by generating degree-of-association information and registering the degree-of-association information in the degree-of-association information database 18. For example, in the case where two pieces of user operation information are recorded in the user operation information database 17 in response to operations performed by an identical user on two different documents within a certain period of time, if a combination of the types of operations on these two documents is the first combination, these two documents are associated with each other to generate degree-of-association information, and the degree-of-association information is registered in the degree-of-association information database 18. If the combination is not the first combination, the degree of association set in corresponding degree-of-relevance information is set to increase.

In the case where a document is selected by the user as a target of operation, the display information generator 14 edits degree-of-association information corresponding to this document, and generates information for display (hereinafter “display information”) related to this document that serves as a target of operation. The display controller 15 performs control to display the display information generated by the display information generator 14.

Each data configuration of the user operation information database 17, the degree-of-association information database 18, and the reflected information database 19 will be described along with the description of the operation of the present exemplary embodiment since various pieces of information are generated or updated as necessary.

The elements 11 to 15 of the document management apparatus 10 are realized by cooperation between a computer that forms the document management apparatus 10 and a program that runs on a CPU mounted in the computer. In addition, the databases 16 to 19 are realized by an HDD mounted in the document management apparatus 10.

Alternatively, RAM or external memory may be used via a network. Although necessary elements are mounted in one document management apparatus 10 to form the document management apparatus 10 in the present exemplary embodiment, necessary elements may be distributedly arranged in a plurality of computers to configure a document management system including the plurality of computers.

In addition, programs used in the present exemplary embodiment may be provided not only by communication means but also by being stored in a computer-readable recording medium such as compact disc read-only memory (CD-ROM) or Universal Serial Bus (USB) memory. Programs provided from communication means or a recording medium are installed in a computer, and a CPU in the computer sequentially executes the programs to realize various processes.

Next, the operation of the present exemplary embodiment will be described. In the present exemplary embodiment, the operation is roughly divided into a process of setting degree-of-association information in response to a user operation, and a process of providing information to the user on the basis of degree-of-association information. At first, a process of setting degree-of-association information in response to a user operation will be described.

In response to some operation, such as viewing or editing, performed by the user on a document managed by the document management apparatus 10, the user operation detector 12 detects that user operation, generates user operation information, and registers the user operation information in the user operation information database 17. For example, the document management apparatus 10 may allow the user to specify the operation mode at the start of the operation such that the user may be able to perform an operation on the document. In the present exemplary embodiment, the description assumes that a view mode that only allows reference, and an edit mode that allows updating are prepared as operation modes.

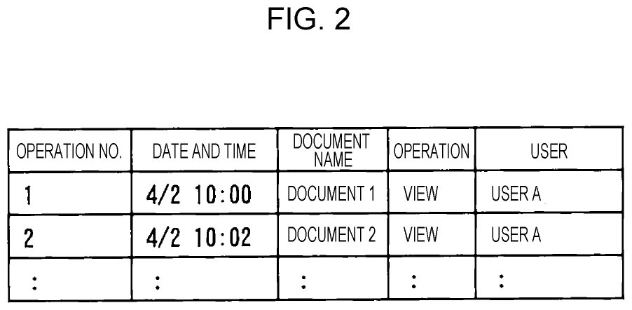

FIG. 2 is a diagram illustrating an exemplary data configuration of user operation information stored in the user operation information database 17 in the present exemplary embodiment. User operation information is generated for each user operation and is registered in the user operation information database 17. In user operation information, the item values of “date and time”, “document name”, “operation”, and “user” are set in association with an identification number (operation No.) for identifying the user operation. “Date and time” is date and time information for specifying the date and time at which the user operation was executed. In the present exemplary embodiment, the start date and time of the user operation is set. However, it is not necessary to restrict the date and time information to the start date and time as long as it is information that may specify the time at which the user operation was performed, such as the end date and time. The name of a document that serves as a target of operation is set in “document name”. Identification information such as a document ID may be used as long as it is information that may specify a document that serves as a target of operation. The type of operation performed by the user is set in “operation”. The user name of a user who performed the operation is set in “user”. Identification information such as a user ID may be used as long as it is information that may specify a user who performed the operation.

In the case where the document management apparatus 10 separately accumulates user operation log information in a log information database (not illustrated), the user operation detector 12 may detect a user operation by referring to log information registered in the log information database without directly detecting a user operation by constantly monitoring an operation performed by the user.

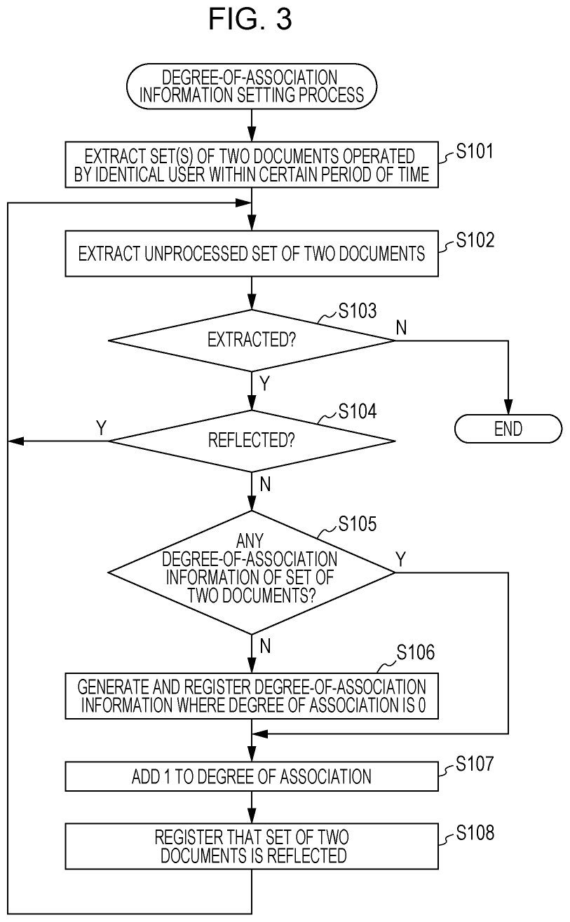

Next, referring to the details registered in the user operation information database 17, a degree-of-association information setting process of setting degree-of-association information will be described using the flowchart illustrated in FIG. 3. This process may be executed by periodical operation of the degree-of-association information management unit 13, or may be executed whenever user operation information is registered.

The degree-of-association information management unit 13 checks whether or not two pieces of user operation information are recorded in the user operation information database 17 in response to operations performed by an identical user on two different documents within a certain period of time. The degree-of-association information management unit 13 extracts one or more sets of corresponding two documents (step S101). Referring to user operation information of operation No. 1 and operation No. 2 illustrated in FIG. 2, user A performed operations on document 1 and document 2, which are different documents, within a certain period of time (such as within two minutes). Thus, the degree-of-association information management unit 13 extracts a set of document 1 and document 2 operated by user A.

Next, the degree-of-association information management unit 13 applies the following processing to each of the extracted combinations. At first, the degree-of-association information management unit 13 extracts an unprocessed set of two documents from the extracted sets (step S102). If there is no unprocessed set and no set is extracted (N in S103), the degree-of-association information setting process ends.

In response to extraction of an unprocessed set (Y in step S103), the degree-of-association information management unit 13 refers to the reflected information database 19 to check whether or not this set is reflected in degree-of-association information. The data configuration of the reflected information database 19 will be described later. In the case where this set is reflected in degree-of-association information (Y in step S104), the degree-of-association information management unit 13 advances the processing to the next unprocessed set (S102).

In the case where this set is not reflected in degree-of-association information (N in step S104), the degree-of-association information management unit 13 checks whether or not degree-of-association information corresponding to this set is registered in the degree-of-association information database 18. Here, in the case where degree-of-association information corresponding to this set is not registered in the degree-of-association information database 18 (N in step S105), the degree-of-association information management unit 13 generates degree-of-association information corresponding to this set, and registers the degree-of-association information in the degree-of-association information database 18 (step S106).

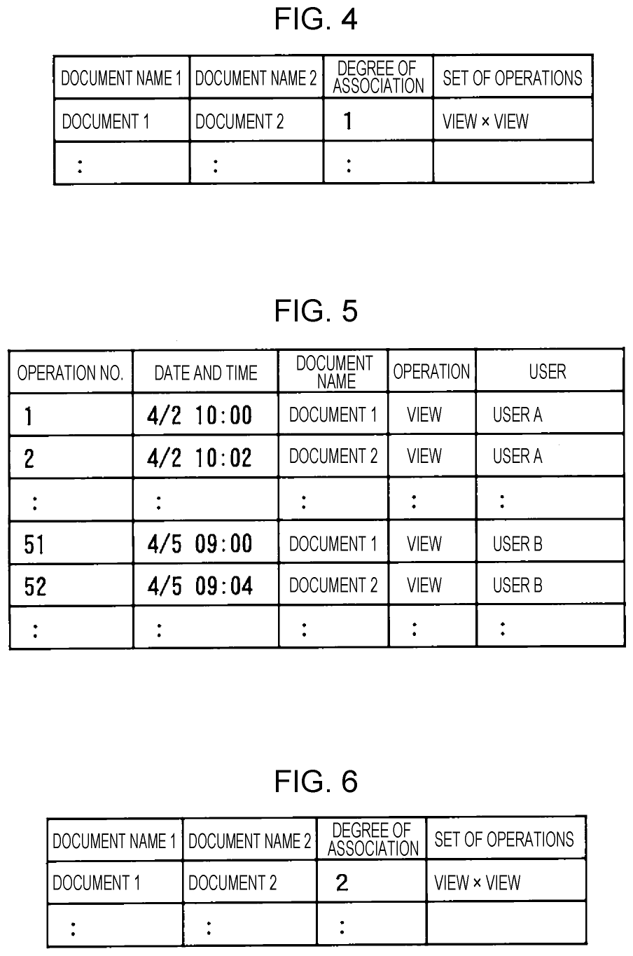

FIG. 4 is a diagram illustrating an exemplary data configuration of degree-of-association information stored in the degree-of-association information database 18 in the present exemplary embodiment. A set of “document name 1”, “document name 2”, “set of operations”, and “degree of association” is set in degree-of-association information. Since a set of two documents is handled in the present exemplary embodiment, the document names of documents constituting this set are set in “document name 1” and “document name 2”. A set of types of user operations performed on the individual documents is set in “set of operations”. In the setting example illustrated in FIG. 2, it is recognized that a view operation was performed on each of document 1 and document 2. Thus, a combination of these types of operations “view×view” is set in FIG. 4. “Degree of association” is a value indicting the degree of association of documents constituting this set. The larger the value of the degree of association, the greater the degree of association between the documents. When new degree-of-association information is generated, 0 is set as the initial value.

In the case where new degree-of-association information is generated, the degree-of-association information management unit 13 adds 1 to the initialized degree of association (step S107). FIG. 4 illustrates a setting example after new degree-of-association information corresponding to a set of document 1 and document 2 is generated, and 1 is added. In contrast, in the case where degree-of-association information corresponding to this set is already registered in the degree-of-association information database 18 (Y in step S105), the degree-of-association information management unit 13 adds 1 to the current value of the degree of association in degree-of-association information corresponding to this combination (step S107).

Accordingly, the setting process based on the set of document 1 and document 2 in user operation information of operation No. 1 and operation No. 2 ends. Information indicating that this set is reflected in the degree of association in the degree-of-association information is registered in the reflected information database 19 (step S108). For example, the operation Nos. may simply be combined as a set and registered in the reflected information database 19.

FIG. 5 is a diagram illustrating another setting example of the user operation information stored in the user operation information database 17 in the present exemplary embodiment. FIG. 5 illustrates a setting example in the case where, due to the elapse of time from the registration circumstances illustrated in FIG. 2, pieces of user operation information of operation No. 51 and operation No. 52 are registered. Referring to the pieces of user operation information of operation No. 51 and operation No. 52 illustrated in FIG. 5, user B performed viewing operations on document 1 and document 2, which are different documents, within a certain period of time. Thus, the degree-of-association information management unit 13 extracts a set of document 1 and document 2 operated by user B. Accordingly, the degree-of-association information management unit 13 extracts a set of document 1 and document 2 operated by user B, included in the pieces of user operation information of operation No. 51 and operation No. 52, in the above-described degree-of-association information setting process (step S102). The set of document 1 and document 2 operated by user B has not been reflected yet in the degree of association (N in step S104), but degree-of-association information indicating that the types of operations on a set of these documents are both viewing (“view×view”) is already registered in the degree-of-association information database 18 (Y in step S105). Thus, the degree-of-association information management unit 13 adds 1 to the current value of the degree of association in the degree-of-association information corresponding to this set (step S107). FIG. 6 illustrates a setting example of the degree-of-association information of this set of documents after the addition. That is, the degree of association corresponding to the set of document 1 and document 2 whose types of operations are “view×view” is updated to 2 since 1 is added.

As has been described above, in the present exemplary embodiment, instead of simply determining that two documents are related depending on whether or not there is an operation on a second document during an operation on a first document, for a set of two documents and the types of operations performed on these two documents, how often these operations are performed is represented by an index value which is the degree of association. In short, the degree of association of two documents is not simply expressed as whether the two documents are associated or not.

Next, a process of providing information to the user on the basis of degree-of-association information will be described.

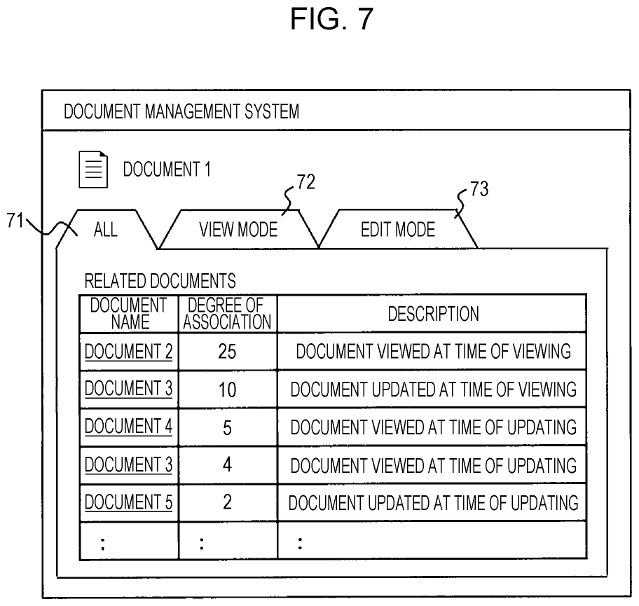

FIG. 7 is a diagram illustrating a screen display example when information regarding the degree of association is displayed on a terminal apparatus used by the user in the present exemplary embodiment. The display controller 15 displays the screen illustrated in FIG. 7 in response to a request from the user.

When the user selects, for example, a document (“document 1” in the example illustrated in FIG. 7) that serves as a target of operation from a list of documents, the terminal apparatus sends an information providing request including identification information (such as the document name) of that document to the document management apparatus 10.

The display information generator 14 in the document management apparatus 10 refers to the degree-of-association information database 18 to extract pieces of degree-of-association information in which “document 1” selected as a target of operation is set in “document name 1” or “document name 2” of degree-of-association information, and rearranges the extracted pieces of degree-of-association information in descending order of degree of association to generate display information. The display controller 15 displays the generated display information as information regarding a related document(s) of “document 1” on the terminal apparatus.

In FIG. 7, in “document name” included in information regarding a related document, a related document of a document that serves as a target of operation (“document 1” in the example illustrated in FIG. 7) is displayed. Specifically, the document name of a document set in the degree-of-association information as a set along with “document 1”, which serves as a target of operation, is displayed. The degree of association between a document that serves as a target of operation and this document is displayed in “degree of association”. “Description” is displayed with reference to a set of operations set in this degree-of-association information. For example, in the case where the type of operation on a document that serves as a target of operation is viewing and the type of operation on this document is editing, “document updated at the time of viewing” is displayed in “description”. In this manner, an operation described after “at the time of” included in “description” is an operation on a document that serves as a target of operation, and an operation described before “at the time of” is an operation on this operation. Note that, in FIG. 7, regarding document 3 by way of example, in the case where a combination of the types of operations performed on document 1 and document 3 is different, this is displayed as a different piece of information since the degree-of-association information is different in the first place.

From these displayed details, the user may be notified of a document that is closely related to “document 1”, and a combination of the types of operations performed on document 1 and this document. Alternatively, this document may be displayed on the screen by selecting the document name in a list of related documents. At that time, the document may be displayed in an operation mode according to a corresponding operation, such as view mode or edit mode.

In the present exemplary embodiment, as illustrated in FIG. 7, the user may be allowed to select a desired one of tabs 71, 72, and 73 to select and display a corresponding one of the following cases: the case of displaying all operations on “document 1”; the case of displaying only information related to the case in which “document 1” is operated in view mode; and the case of displaying only information related to the case in which “document 1” is operated in edit mode.

Alternatively, degree-of-association information to be displayed may be selected in accordance with the type of operation on a document that serves as a target of operation. For example, in the case where a document that serves as a target of operation is operated in view mode, regarding the other document of the set, only degree-of-association information whose type of operation is “update” is to be displayed. Alternatively, in the case where a document that serves as a target of operation is operated in edit mode, regarding the other document of the set, only degree-of-association information whose type of operation is “view” is to be displayed.

By the way, as has been described above, user operation information generated by performing, by one user, operations on two different documents within a certain period of time are extracted from the user operation information database 17, and degree-of-association information is set. This is such that, because the user performs operations on two documents within a certain period of time, degree-of-association information is set assuming that the two documents are related. However, another case is also conceivable in which, because the user is simultaneously performing different tasks on the terminal apparatus, the user simultaneously performs operations on documents related to the individual tasks. In this case, even though these documents are not related, because the user simultaneously performs operations on these documents, degree-of-association information is set to these documents.

If user A simultaneously performs operations on documents (such as document α and document β) in different tasks (such as task α and task β) in the same combination as one described above, it is considered that it is not very likely that a different user B similarly performs simultaneous operations on these documents (document α and document β) in these different tasks (task α and task β). In short, even if degree-of-association information is generated for a combination of unrelated document 1 and document 2 and is registered in the degree-of-association information database 18, it is considered that the degree of association corresponding to that combination of documents is relatively unlikely to increase thereafter.

According to the display example illustrated in FIG. 7, if all pieces of information related to a document that serves as a target of operation (that is, “document 1”) are displayed, information regarding a document unrelated to document 1 may also be displayed. However, the degree of association corresponding to an unrelated document remains low because there is almost no chance for this degree of association to increase, and accordingly, such information is displayed in a lower portion of the list of related documents. Accordingly, the user may determine that this document is a document unrelated to document 1 or a document that is very little related to document 1.

Note that it is assumed that the date and time set in user operation information is the start date and time, as described above. By taking into consideration such a case in which the user immediately stops an operation on a document after starting the operation, two documents forming a set are not always operated at the same time from the date and time set in user operation information. In the present exemplary embodiment, it is assumed that operations started within a certain period of time and the above-mentioned simultaneous operations mean the same.

As described above, although all pieces of degree-of-association information corresponding to “document 1” are to be displayed in the present exemplary embodiment, for example, degree-of-association information of only the top n (n is an integer greater than or equal to 1) degrees of association may be displayed, or only degree-of-association information whose degree of association is greater than or equal to a preset threshold may be displayed. Note that, instead of preparing only one threshold, a threshold may be set according to the property, such as the type, of a document.

In FIG. 7, the user is presented the degree of association with a document related to a document selected as a document that serves as a target of operation. Next, as another method of presenting information, the case in which a message regarding an operation on a related document is displayed will be discussed.

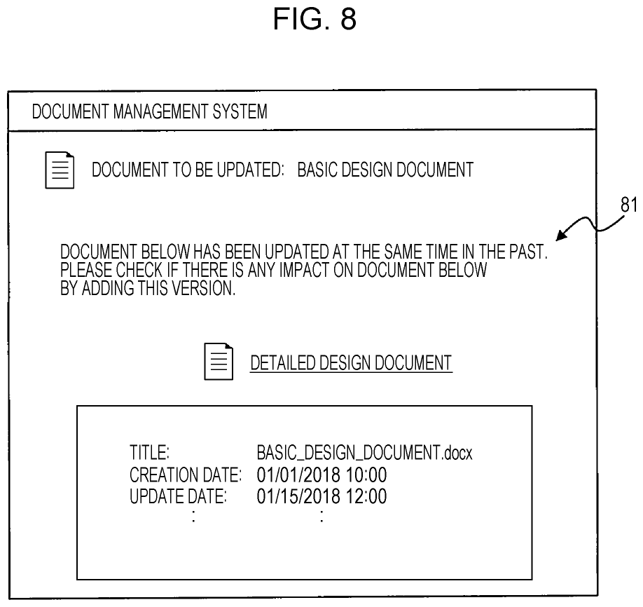

FIG. 8 is a diagram illustrating a screen display example of a message regarding an operation on a related document in the present exemplary embodiment. When the user selects, for example, a document that serves as a target of operation (“basic design document” in the example illustrated in FIG. 8) from a list of documents in order to operate that document in edit mode, the terminal apparatus sends an information providing request including identification information (such as the document name) of that document to the document management apparatus 10.

The display information generator 14 in the document management apparatus 10 refers to the degree-of-association information database 18 to extract one or more pieces of degree-of-association information in which the basic design document selected as a target of operation is set in “document name 1” or “document name 2” of the degree-of-association information. The display information generator 14 refers to the extracted pieces of degree-of-association information to extract a document that is related as a related document. Here, a document whose type of operation is “update” and which has the maximum degree of association is extracted as a related document. The display controller 15 causes the terminal apparatus to display the document that serves as a target of operation in edit mode, and to display a message 81 regarding an operation on the extracted related document.

According to the screen display example illustrated in FIG. 8, a “detailed design document” is extracted as a related document of the document that serves as a target of operation (that is, “basic design document”), and the message 81 indicating a relationship with the “basic design document” is displayed. In addition, the character string “detailed design document” is displayed in a selectable manner. When the user, who refers to the displayed message 81, determines that it is better to update the “detailed design document” at the same time, the user selects “detailed design document”. The display controller 15 causes the terminal apparatus to display the related document (that is, “detailed design document”) in edit mode in response to this operation.

In this manner, according to the present exemplary embodiment, a document that should be updated at the same time may be presented to the user.

Although the example in which only one document is displayed as a related document has been illustrated in FIG. 8, a plurality of documents may be displayed as related documents. For example, in relation to a document that serves as a target of operation, documents with the top n degrees of association (n is an integer greater than or equal to 1) may be displayed, or documents whose degree of association is greater than or equal to a preset threshold may be displayed. Note that, instead of preparing only one threshold, a threshold may be set according to the property, such as the type, of a document.

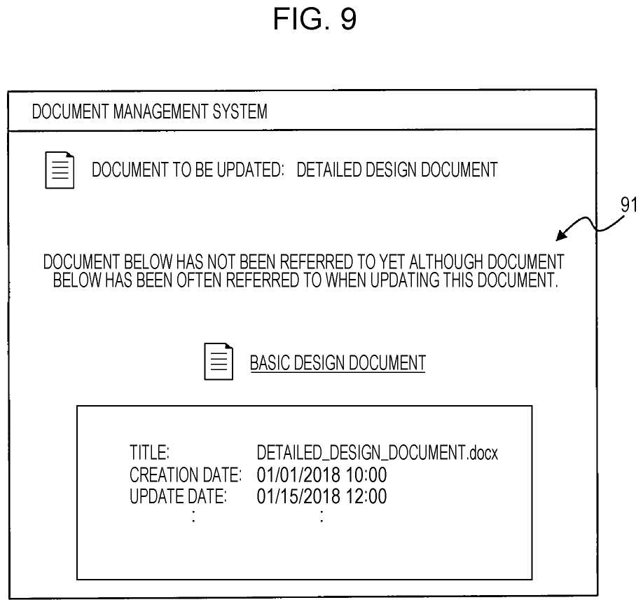

FIG. 9 is a diagram illustrating a screen display example of another message regarding an operation on a document in the exemplary embodiment. When the user selects, for example, a document that serves as a target of operation (“detailed design document” in the example illustrated in FIG. 9) from a list of documents in order to operate that document in edit mode, the terminal apparatus sends an information providing request including identification information (such as the document name) of that document to the document management apparatus 10.

The display information generator 14 in the document management apparatus 10 refers to the degree-of-association information database 18 to extract one or more pieces of degree-of-association information in which the detailed design document selected as a target of operation is set in “document name 1” or “document name 2” of the degree-of-association information. The display information generator 14 refers to the extracted pieces of degree-of-association information to extract a document that is related as a related document. Here, a document whose type of operation is “view” and which has the maximum degree of association is extracted as a related document. The display controller 15 causes the terminal apparatus to display the document that serves as a target of operation in edit mode, and to display a message 91 regarding an operation on the extracted related document.

According to the screen display example illustrated in FIG. 9, a “basic design document” is extracted as a related document of the document that serves as a target of operation (that is, “detailed design document”), and the message 91 indicating a relationship with the “detailed design document” is displayed. In addition, as in FIG. 8, the character string “basic design document” is displayed in a selectable manner. When the user, who refers to the message 91, determines that it is better to view the “basic design document” at the same time, the user selects “basic design document”. The display controller 15 causes the terminal apparatus to display the related document (that is, “basic design document”) in view mode in response to this operation.

In this manner, according to the present exemplary embodiment, a document that should be referred to at the time of updating a document may be presented to the user.

Although the example in which only one document is displayed as a related document has been illustrated in FIG. 9, a plurality of documents may be displayed as related documents. For example, in relation to a document that serves as a target of operation, documents with the top n degrees of association (n is an integer greater than or equal to 1) may be displayed, or documents whose degree of association is greater than or equal to a preset threshold may be displayed. Note that, instead of preparing only one threshold, a threshold may be set according to the property, such as the type, of a document.

By the way, document viewing and editing are used as examples of the types of operations on documents in the above description. When corresponding operations are confirmed, 1 is added to the degree of association. However, the types of operations based on which the degree of association is increased need not be restricted to the above exemplary types.

For example, in a multi-window system that provides an operation environment displaying a plurality of screens, it is commonly done to display documents respectively on a plurality of screens (may also be referred to as “windows”). In the case where documents are respectively displayed on two screens, the user may sometimes switch a screen that serves as a target of operation (that is, an “active window”). From the fact that the active window is switched, it may be estimated that, since these two documents are operated at the same time, these two documents are related documents. This operation of switching the active window is not an operation recorded in the log information database of the document management apparatus 10, and may not be a type of operation that the user operation detector 12 records in the user operation information database 17. However, the above-discussed operation of switching the active window is an operation based on which it may be estimated that two documents displayed on the respective windows are related. Therefore, in response to detection by the user operation detector 12 of execution of the operation of switching the active window, the degree-of-association information management unit 13 may increase the degree of association included in the degree-of-association information in response to this execution of the switching operation. For example, the degree of association may be increased in response to n or more times (n is an integer greater than or equal to 1) execution of the operation of switching the active window within a certain period of time.

By the way, it has been described that, in the case where an identical user performs operations on two different documents within a certain period of time, 1 is added to the degree of association corresponding to a combination of a set of these two documents and the types of operations on these documents. For example, in the case where user A views a set of two documents, 1 is added to the degree of association. In addition, in the case where user B views the same set of two documents, 1 is further added to the degree of association. If ten users view this set of documents, 10 is added to the degree of association. Note that, because ten users have performed operations on the same set of documents, it is likely that these two documents are related. In this case, instead of adding 10 to the degree of association, the degree of association may be increased differently, such as adding 20 to the degree of association, from the normal process illustrated in FIG. 3, such as simply adding 10 to the degree of association. Specifically, 5 is set as the amount of increase of the degree of association for the increase condition that ten users operate a target of operation. In the case where ten users view a set of documents, the degree-of-association information management unit 13 adds 10 to the degree of association. In addition to that, because the above-described increase condition is satisfied, 5 is additionally added to the degree of association. In this manner, increase conditions for increasing the degree of association may be set in advance, and, in the case where any of the increase conditions is satisfied by user operation information registered in the user operation information database 17, the degree-of-association information management unit 13 may determine the amount of increase of the degree of association in accordance with the increase condition satisfied by the user operation information. Accordingly, the degree of association of a set of two documents that are likely to be related may be further increased.

In the present exemplary embodiment, as has been described above, information regarding the degree of association between two documents is presented to the user by paying attention to a set of these two documents. Note that the user may simultaneously operate three or more documents. In such a case, for example, degree-of-association information may be set by expanding three documents to sets of two documents. Alternatively, this case may be handled by adding the item “document name 3” for setting a document to degree-of-association information in addition to “document name 1” and “document name 2”.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a recording unit that records, in memory, user operation information including an execution date and time of an operation performed by a user on a file, a type of the operation, and identification information of the user who performed the operation;
a setting unit that sets a degree of association to increase in a case where two pieces of user operation information are recorded in the memory in response to operations performed by an identical user on two different files within a certain period of time, the degree of association being set in degree-of-association information generated in association with a combination of types of operations performed on the two files, the degree of association indicating the degree of association between the two files; and
a display controller that performs, in a case where a user selects a file as a target of operation, control to display degree-of-association information corresponding to the file.

2. The information processing apparatus according to claim 1, wherein the setting unit increases the degree of association set in the degree-of-association information corresponding to the combination of types of operations on the two files in response to execution of a certain operation which is not a target to be recorded in the memory and based on which the two files being operated are estimated to be related.

3. The information processing apparatus according to claim 2, wherein the certain operation is an operation for switching between screens respectively displaying the two files as a target of operation.

4. The information processing apparatus according to claim 1, wherein the setting unit determines an amount of increase of the degree of association in accordance with a condition for increasing the degree of association, the condition being satisfied by user operation information recorded in the memory.

5. The information processing apparatus according to claim 2, wherein the setting unit determines an amount of increase of the degree of association in accordance with a condition for increasing the degree of association, the condition being satisfied by user operation information recorded in the memory.

6. The information processing apparatus according to claim 1, wherein the display controller arranges and displays pieces of the degree-of-association information corresponding to a file selected as a target of operation in descending order of the degree of association included in the pieces of the degree-of-association information.

7. The information processing apparatus according to claim 1, wherein the display controller selects degree-of-association information to be displayed in accordance with a type of operation on a file selected as a target of operation.

8. The information processing apparatus according to claim 6, wherein the display controller selects degree-of-association information to be displayed in accordance with a type of operation on a file selected as a target of operation.

9. The information processing apparatus according to claim 1, wherein the display controller displays a message regarding an operation on a file related to a file selected as a target of operation.

10. A non-transitory computer readable medium storing a program causing a computer to execute a process, the process comprising:
recording, in memory, user operation information including an execution date and time of an operation performed by a user on a file, a type of the operation, and identification information of the user who performed the operation;
setting a degree of association to increase in a case where two pieces of user operation information are recorded in the memory in response to operations performed by an identical user on two different files within a certain period of time, the degree of association being set in degree-of-association information generated in association with a combination of types of operations performed on the two files, the degree of association indicating the degree of association between the two files; and
performing, in a case where a user selects a file as a target of operation, control to display degree-of-association information corresponding to the file.

11. An information processing apparatus comprising:
recording means for recording, in memory, user operation information including an execution date and time of an operation performed by a user on a file, a type of the operation, and identification information of the user who performed the operation;
setting means for setting a degree of association to increase in a case where two pieces of user operation information are recorded in the memory in response to operations performed by an identical user on two different files within a certain period of time, the degree of association being set in degree-of-association information generated in association with a combination of types of operations performed on the two files, the degree of association indicating the degree of association between the two files; and
display control means for performing, in a case where a user selects a file as a target of operation, control to display degree-of-association information corresponding to the file.
